(19) United States
(12) Patent Application Publication
(10) Pub. No.: US 2025/0252624 A1
(43) Pub. Date: Aug. 7, 2025

(54) SKETCH TO IMAGE GENERATION USING CONTROL NETWORK

(71) Applicant: ADOBE INC., SAN JOSE, CA (US)

(72) Inventors: Zongze Wu, San Francisco, CA (US); Daichi Ito, San Jose, CA (US); Zhifei Zhang, San Jose, CA (US); Qing Liu, Santa Clara, CA (US); Elya Shechtman, Seattle, WA (US); Zhe Lin, Clyde Hill, WA (US)

(21) Appl. No.: 18/432,580

(22) Filed: Feb. 5, 2024

(51) Int. Cl. G06T 11/20; G06T 3/02; G06T 3/18; G06T 7/13; G06T 11/60

(52) U.S. Cl. CPC G06T 11/203; G06T 3/02; G06T 3/18; G06T 7/13; G06T 11/60

(57) ABSTRACT

A method, apparatus, non-transitory computer readable medium, and system for image generation include obtaining a sketch input and a value of a fidelity parameter indicating a level of adherence to the sketch input. The sketch input and the value of the fidelity parameter are encoded to obtain sketch guidance information. Then a synthesized image is generated based on the sketch guidance information. The synthesized image depicts an object from the sketch input based on the fidelity parameter.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, includes the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation. Embodiments of the present disclosure include an image generation apparatus configured to obtain a sketch input (e.g., scribbles, artistic and professional sketch) and a user-specified fidelity parameter as inputs and generate a synthesized image using an image generation model. The synthesized image depicts an object from the sketch input based on the fidelity parameter, and the image generation model is trained using training data having a distortion level corresponding to the fidelity parameter. In some embodiments, the image generation model is trained to incorporate fidelity control mechanism so users can control how well the output image should follow the sketch input. For example, if a small fidelity parameter is selected during inference time, a synthesized image precisely follows the layout and structure of the sketch input. If a large fidelity parameter is selected during inference, a synthesized image roughly or loosely follows the sketch input.

A method, apparatus, and non-transitory computer readable medium for image generation are described. One or more embodiments of the method, apparatus, and non-transitory computer readable medium include obtaining a sketch input and a value of a fidelity parameter indicating a level of adherence to the sketch input; encoding, using a control network of an image generation model, the sketch input and the value of the fidelity parameter to obtain sketch guidance information; and generating, using the image generation model, a synthesized image based on the sketch guidance information, wherein the synthesized image depicts an object from the sketch input based on the fidelity parameter.

A method, apparatus, and non-transitory computer readable medium for image generation are described. One or more embodiments of the method, apparatus, and non-transitory computer readable medium include initializing an image generation model; obtaining a training set including an image, a sketch input corresponding to the image, and a distortion level of the sketch input; and training, using the training set, the image generation model to generate images based on the sketch input and a fidelity parameter corresponding to the distortion level.

An apparatus and method for image generation are described. One or more embodiments of the apparatus and method include at least one processor; at least one memory including instructions executable by the at least one processor; and a machine learning model comprising parameters in the at least one memory configured to obtain a sketch input and a value of a fidelity parameter indicating a level of adherence to the sketch input, wherein the machine learning model comprises a control network trained to encode the sketch input and the value of the fidelity parameter to obtain sketch guidance information, and wherein the machine learning model further comprises an image generator trained to generate a synthesized image based on the sketch guidance information using training data having a distortion level corresponding to the fidelity parameter.

### BRIEF DESCRIPTION OF THE DRAWINGS

FIG. 1 shows an example of an image generation system according to aspects of the present disclosure.

FIG. 2 shows an example of a method for sketch-based image generation according to aspects of the present disclosure.

FIG. 3 shows an example of sketch-based image generation and effect of distortion levels according to aspects of the present disclosure.

FIG. 4 shows an example of a method for image generation according to aspects of the present disclosure.

FIG. 5 shows an example of an image generation apparatus according to aspects of the present disclosure.

FIG. 6 shows an example of an image generation model comprising a control network according to aspects of the present disclosure.

FIG. 7 shows an example of a control network of an image generation model according to aspects of the present disclosure.

FIG. 8 shows an example of a guided latent diffusion model according to aspects of the present disclosure.

FIG. 9 shows an example of a machine learning model according to aspects of the present disclosure.

FIGS. 10 to 12 show examples of predicted images at various time steps via a diffusion process according to aspects of the present disclosure.

FIG. 13 shows an example of a method for training an image generation model according to aspects of the present disclosure.

FIG. 14 shows an example of affine transformation and image warping according to aspects of the present disclosure.

FIGS. 15 and 16 show examples of edge detection according to aspects of the present disclosure.

FIG. 17 shows an example of image warping effect according to aspects of the present disclosure.

FIGS. 18 and 19 show examples of artistic sketch photo creation according to aspects of the present disclosure.

FIG. 20 shows an example of artistic sketch photo pairs creation with shading and color according to aspects of the present disclosure.

FIG. 21 shows an example of artistic sketch photo database according to aspects of the present disclosure.

FIG. 22 shows an example of a computing device for image generation according to aspects of the present disclosure.

### DETAILED DESCRIPTION

The present disclosure describes systems and methods for image generation. Embodiments of the present disclosure include an image generation apparatus configured to obtain a sketch input (e.g., scribbles, artistic and professional sketch) and a user-specified fidelity parameter as inputs and generate a synthesized image using an image generation model. The synthesized image depicts an object from the sketch input based on the fidelity parameter, and the image generation model is trained using training data having a distortion level corresponding to the fidelity parameter. In some embodiments, the image generation model is trained to incorporate fidelity control mechanism so users can control how well the output image should follow the sketch input. For example, if a small fidelity parameter is selected during inference time, a synthesized image precisely follows the layout and structure of the sketch input. If a large fidelity parameter is selected during inference, a synthesized image roughly or loosely follows the sketch input.

Diffusion models are a class of generative neural networks that can be trained to generate new data with features similar to features found in training data. Diffusion models can be used in image completion tasks, such as image inpainting. In some examples, however, diffusion models may generate poor results when they are limited to taking only text information as a condition for image generation tasks. Conventional models have not incorporated sketch inputs drawn by users. Most conditional diffusion models (e.g., DALLE2, Imagen) take text prompts as input and/or depend on pre-trained CLIP or similar embeddings.

These models often fail to generate realistic and desired images in tasks such as image synthesis and image inpainting when target output images are complicated. For example, it is difficult to come up with text prompts that can describe the exact body pose, head direction, ear type, and spot pattern on the skin using just natural language. At the end of the day, a sketch image is worth a thousand words and can describe increasingly complicated scenes compared to text prompts.

Embodiments of the present disclosure include an image generation apparatus configured to generate a synthesized image based on a sketch image (e.g., scribbles) and a fidelity parameter. The sketch image is used as a condition to control the structure, layout, and color of objects. A machine learning model is trained to incorporate fidelity control mechanism so users can easily control how well the output image should follow the sketch input. For example, if a small fidelity parameter is selected during inference time, a synthesized image precisely follows the structure of the sketch input. If a large fidelity parameter is selected during inference, a synthesized image roughly or loosely follows the sketch input. This way, it would fit the user case for both rough sketch (layman users) and precise sketch (professional users) while creating realistic and desired images. In some examples, the machine learning model (or image generation model) comprises U-Net architecture and a control network (e.g., ControlNet adaptor). At training, the machine learning model learns different distortion levels and corresponding augmented edge maps as sketch inputs, which are fed into the control network.

In some embodiments, the control network of the image generation model is trained using pairs of sketch images and corresponding photo realistic images. In some cases, rough doodle is generated to simulate the sketch input from layman users, and in time meantime, different style of artistic sketch (e.g., fine-grained sketch) to simulate input from professional artists. For training the machine learning model, some embodiments randomly sample three types of edges, that are clean HED edge, clean entity edge, and mixed edge. The term “clean HED edge” refers to a first type of edges generated using a process of creating edges based on holistically-nested edge detection. The term “clean entity edge” refers to a second type of edges generated using a process of creating entity edges based on obtaining entity segmentation of images and applying Sobel filter to the entity segmentation. The term “mixed edge “refers to a third type of edges generated by merging the first type and the second type.

To simulate the inaccurate edges drawn by layman users, some embodiments perform random affine transformation and random image warping. The level of these two transformations is controlled by distortion level. To enable users to control how well the synthesized image should follow the sketch input, in some examples, the distortion level α is input into the ControlNet adaptor as class labels. That is, distortion level α and the corresponding augmented edge map are input to ControlNet adaptor as condition. If a small α is selected during inference, the generated image precisely follows the structure and layout of the sketch input. This would lead to artifacts if the sketch input is rough and unrealistic, which happens frequently for layman users. If a large α is selected during inference, the generated image would roughly or loosely follow the sketch input and look relatively more realistic. The fidelity parameter α fits the user case for rough sketch (drawn by layman users) and precise sketch (drawn by professional users).

Embodiments of the disclosure include systems and methods that improve on conventional image generation models by generating more accurate output. That is, the generated images are more closely aligned with the output desired by the user. Furthermore, the process for generating these images is more efficient for the user (i.e., it reduces the amount of editing and iteration), and gives the user more control by allowing them to select a fidelity parameter that determines fidelity of the output to a sketch input. Some embodiments achieve this improve accuracy and efficiency using an architecture that takes the sketch as an input to an image generation model that is trained using training data having a distortion level corresponding to the fidelity parameter.

Embodiments of the present disclosure enable sketch to image generation for layman users and professional artists by selecting from a range of fidelity parameters that correspond to different distortion levels (e.g., edge distortion). Unlike conventional models, the image generation model described in the present disclosure can process inaccurate sketch inputs that are rough low-quality doodles and also handle high-quality professional sketches with complex shadings and colors. The image generation model is trained using specifically selected training data. During training, edge detection and entity segmentation techniques, along with random affine transformation and image warping, are applied to images in the training data to sample different types of edges that represent possible inaccurate doodle from layman users. One or more embodiments of the present disclosure increase the accuracy, efficiency, and controllability in text to image generation by integrating a sketch input and a fidelity parameter (corresponding to a distortion level) as inputs to an image generator (e.g., a diffusion model). Accordingly, generated images are of increased quality and fidelity.

Additionally, the image generation model is not dependent on a detailed text prompt for image synthesis or image inpainting, which may be difficult to come up with for certain tasks. Instead, the image generation model takes a sketch input that is hand-drawn by a user and more efficiently generates a synthesized image. The synthesized image preserves layout structure as in the sketch input and has increased image quality and fidelity.

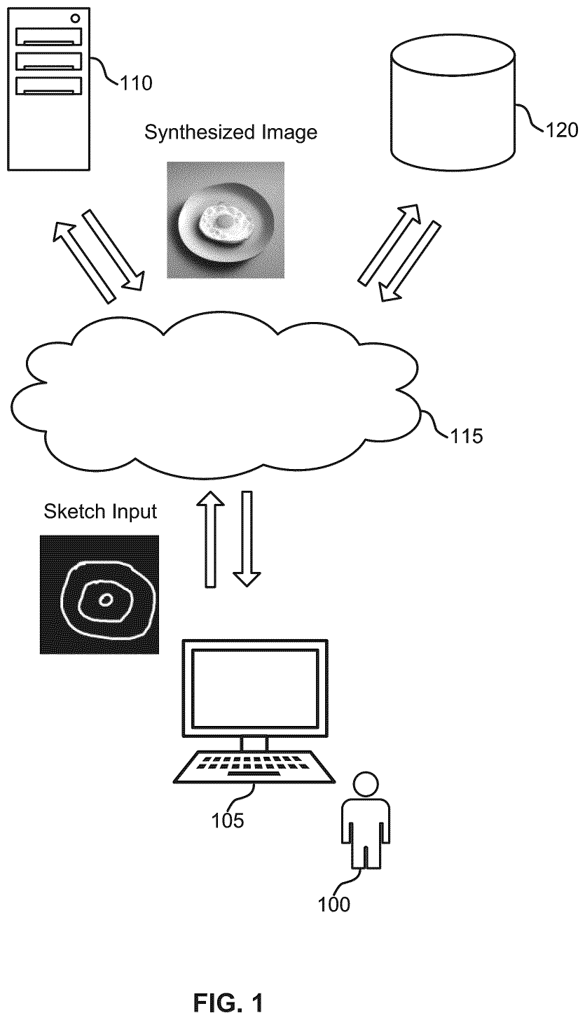

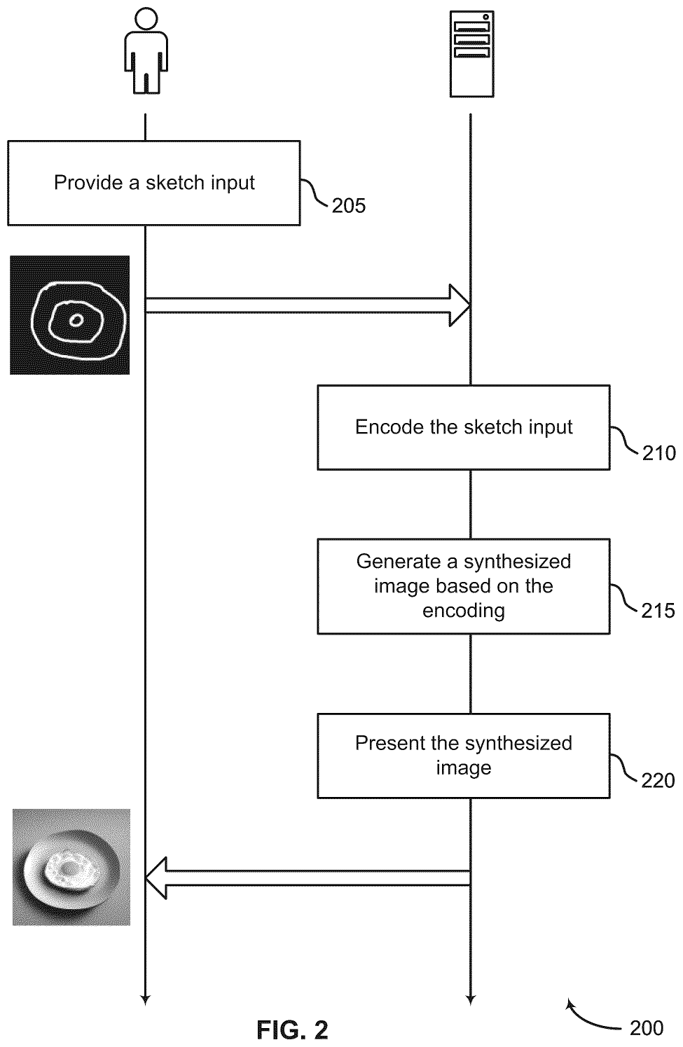

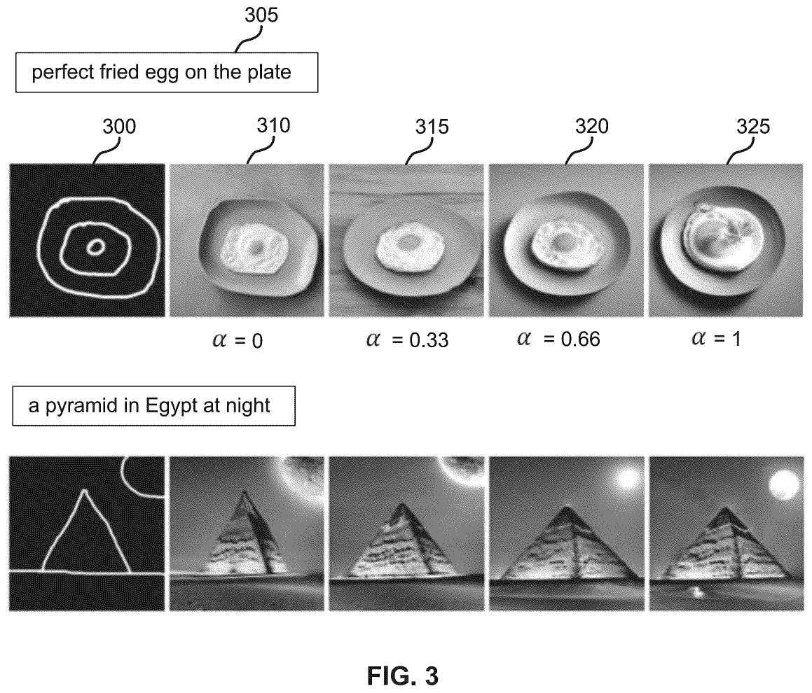

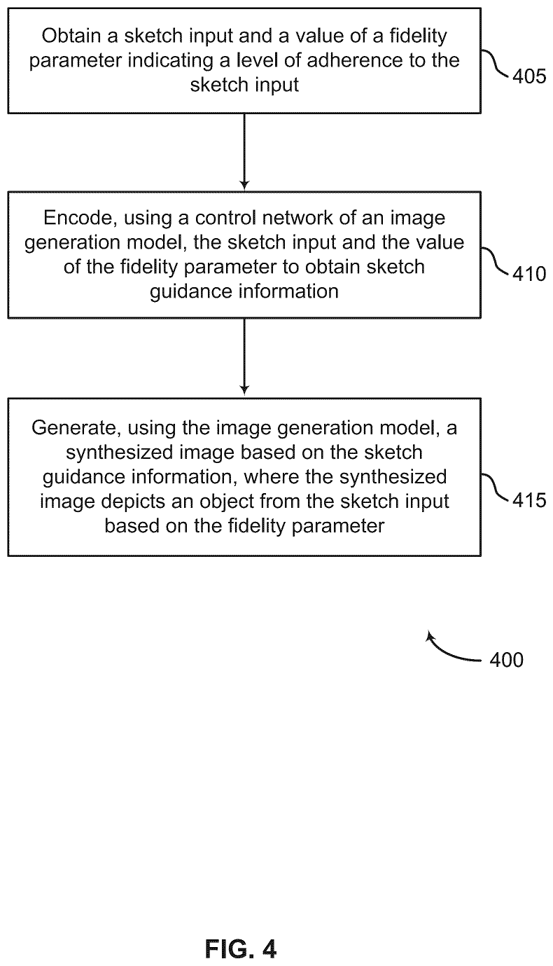

In some examples, an image generation apparatus based on the present disclosure receives a sketch input and a value of a fidelity parameter, and then generates a synthesized image based on the sketch input and the fidelity parameter. An example application in the sketch to image generation context is provided with reference to FIGS. 2-3. Details regarding the architecture of an example image generation system are provided with reference to FIGS. 1 and 5-9. Details regarding the process of image generation are provided with reference to FIGS. 4 and 10-12.

### Sketch to Image Generation

In FIGS. 1-4, a method, apparatus, and non-transitory computer readable medium for image generation are described. One or more embodiments of the method, apparatus, and non-transitory computer readable medium include obtaining a sketch input and a value of a fidelity parameter indicating a level of adherence to the sketch input; encoding, using a control network of an image generation model, the sketch input and the value of the fidelity parameter to obtain sketch guidance information; and generating, using the image generation model, a synthesized image based on the sketch guidance information, wherein the synthesized image depicts an object from the sketch input based on the fidelity parameter.

Some examples of the method, apparatus, and non-transitory computer readable medium further include providing a sketch element in a user interface. Some examples further include receiving the sketch input via the sketch element.

Some examples of the method, apparatus, and non-transitory computer readable medium further include providing a fidelity parameter selection element in a user interface. Some examples further include receiving the value of the fidelity parameter via the fidelity parameter selection element.

Some examples of the method, apparatus, and non-transitory computer readable medium further include receiving an edit to the sketch input. Some examples further include modifying the sketch input based on the edit to obtain a modified sketch input. Some examples further include generating, using the image generation model, a modified image based on the modified sketch input.

Some examples of the method, apparatus, and non-transitory computer readable medium further include displaying a preview of the synthesized image, wherein the edit is received in response to the preview.

Some examples of the method, apparatus, and non-transitory computer readable medium further include performing inpainting operation on a portion of an input image based on the sketch input.

Some examples of the method, apparatus, and non-transitory computer readable medium further include obtaining a text prompt, wherein the synthesized image is generated based on the text prompt. In some examples, the image generation model is trained using training data having a distortion level corresponding to the fidelity parameter.

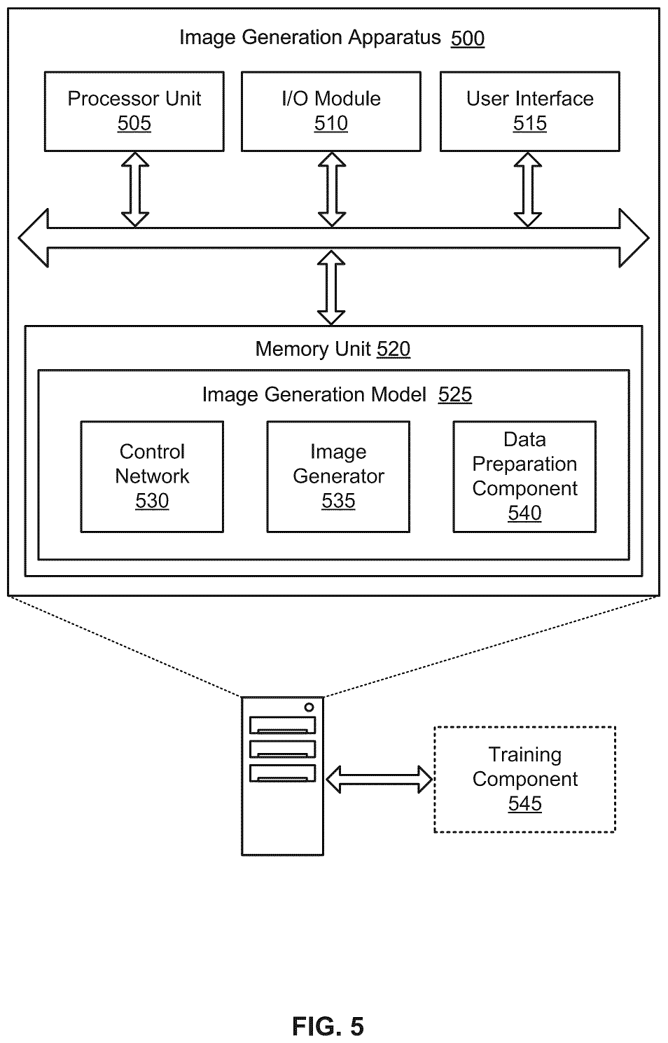

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 5.

In an example shown in FIG. 1, a sketch input (e.g., a doodle) is provided by user 100 and transmitted to image generation apparatus 110, e.g., via user device 105 and cloud 115. User 100 selects or inputs a value of a fidelity parameter indicating a level of adherence to the sketch input. The fidelity parameter provides fidelity control such that user 100 can control how well or how closely the generated image follows the sketch input. In some examples, the sketch input is provided via a sketch element in a user interface. The value of the fidelity parameter is received via a fidelity parameter selection element in the user interface.

In some examples, a control network of image generation apparatus 110 encodes the sketch input and the value of the fidelity parameter to obtain sketch guidance information. Image generation apparatus 110 generates a synthesized image based on the sketch guidance information. The synthesized image depicts an object from the sketch input based on the fidelity parameter. Image generation apparatus 110 is trained using training data having a distortion level corresponding to the fidelity parameter. Image generation apparatus 110 returns the synthesized image to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a user interface may be represented in code which is sent to the user device 105 and rendered locally by a browser.

Image generation apparatus 110 includes a computer implemented network comprising a control network, an image generator, and a data preparation component. Image generation apparatus 110 may also include a processor unit, a memory unit, an I/O module, a user interface, and a training component. The training component is used to train a machine learning model (or an image generation model). Additionally, image generation apparatus 110 can communicate with database 120 via cloud 115. In some cases, the architecture of the image generation network is also referred to as a network, a machine learning model, or a network model. Further detail regarding the architecture of image generation apparatus 110 is provided with reference to FIGS. 5-9. Further detail regarding the operation of image generation apparatus 110 is provided with reference to FIGS. 2 and 4.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with database controller. In other cases, database controller may operate automatically without user interaction.

FIG. 2 shows an example of a method 200 for sketch-based image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides a sketch input and sets a value of a fidelity parameter. In some cases, the operations of this step refer to, or may be performed by, a user as described with reference to FIG. 1. As an example, the sketch input is drawn by a layman user since it's a doodle. The edges in the sketch input is not accurate. The user may select a large-value fidelity parameter during inference, so that a synthesized image may not exactly follow the sketch input and can look more realistic.

At operation 210, the system encodes the sketch input to obtain sketch guidance information. In some cases, the operations of this step refer to, or may be performed by, an image generation apparatus as described with reference to FIGS. 1 and 5. In an embodiment, a control network of the image generation apparatus encodes the sketch input and the value of the fidelity parameter to obtain sketch guidance information.

At operation 215, the system generates a synthesized image based on the encoding (and the sketch guidance information). In some cases, the operations of this step refer to, or may be performed by, an image generation apparatus as described with reference to FIGS. 1 and 5. In an embodiment, an image generator of the image generation apparatus is trained to generate a synthesized image based on the sketch guidance information using training data having a distortion level corresponding to the fidelity parameter. In some cases, a small fidelity parameter corresponds to a distortion level of lesser degree (i.e., a synthesized image precisely follows the structure of the sketch input). A large fidelity parameter corresponds to a distortion level of larger degree (i.e., a synthesized image roughly or loosely follows the sketch input).

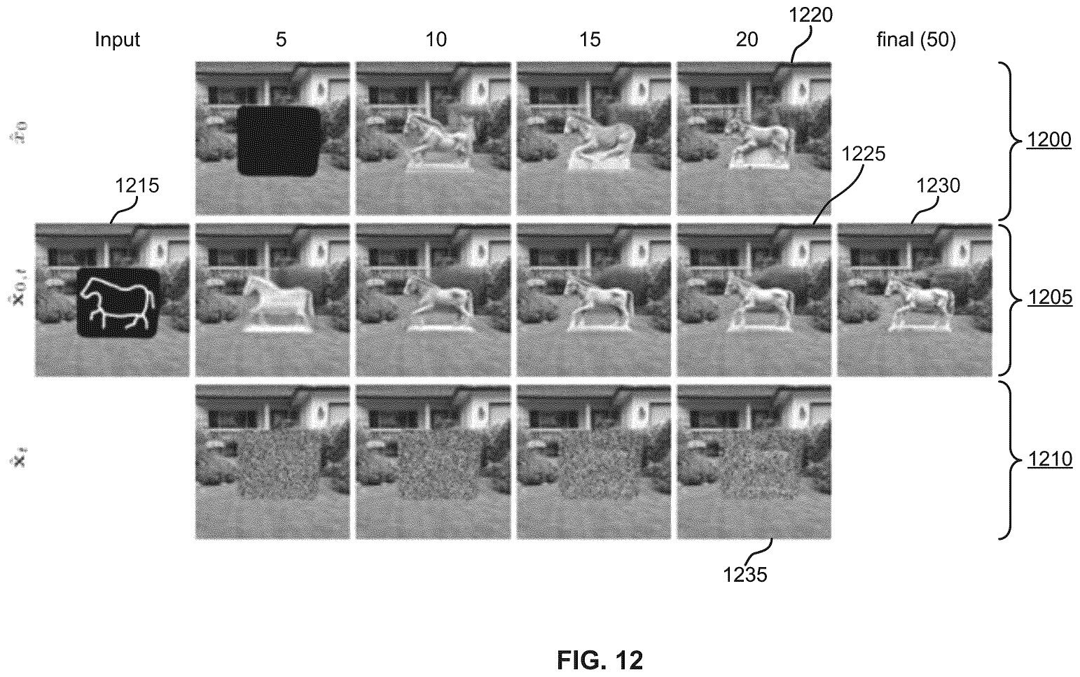

At operation 220, the system presents the synthesized image to the user. In some cases, the operations of this step refer to, or may be performed by, an image generation apparatus as described with reference to FIGS. 1 and 5. In some cases, the user may input an additional sketch input and repeat operations 205, 210 and 215 to generate an additional synthesized image. In some cases, the user may input a sketch input emphasizing an object or an area for image inpainting (see FIG. 12).

FIG. 3 shows an example of sketch-based image generation and effect of different distortion levels according to aspects of the present disclosure. The example shown includes sketch input 300, text prompt 305, first synthesized image 310, second synthesized image 315, third synthesized image 320, and fourth synthesized image 325.

In some cases, when the distortion level α is small, the generated images have the same layout and structure as the input edges. When the distortion level α is large, the synthesized images are more realistic and roughly follow the layout and structure of the input edges. The implementation of distortion level (and corresponding fidelity parameter α) enable use cases of both professional artists which input accurate edges, and layman users which input rough inaccurate edges.

As an example shown in FIG. 3, text prompt 305 is “perfect fried egg on the plate”. By selecting distortion level α=0, first synthesized image 310 closely follows the sketch input 300 and has the same structure as the input edges of sketch input 300. But first synthesized image 310 looks relatively less realistic because a plate is not of round shape and a fried egg has an irregular shape.

By selecting distortion level α=0.33, second synthesized image 315 follows the sketch input 300 to a lesser degree compared to first synthesized image 310 and has roughly same structure as the input edges of sketch input 300. Second synthesized image 315 still looks relatively less realistic because a plate is not of round shape.

By selecting distortion level α=0.66, third synthesized image 320 follows the sketch input 300 to a lesser degree compared to first synthesized image 310 and second synthesized image 315 and roughly follows the structure of the input edges (i.e., not exactly the same structure as the input edges of sketch input 300). Third synthesized image 320 looks relatively more realistic.

By selecting distortion level α=1, fourth synthesized image 325 follows the sketch input 300 to a much lesser degree compared to the other three synthesized images mentioned above and roughly follows the structure of the input edges (i.e., not exactly the same structure as the input edges of sketch input 300). Fourth synthesized image 325 looks realistic because a plate and a fried egg are of round shape even though these objects and the edges in sketch input 300 look irregular.

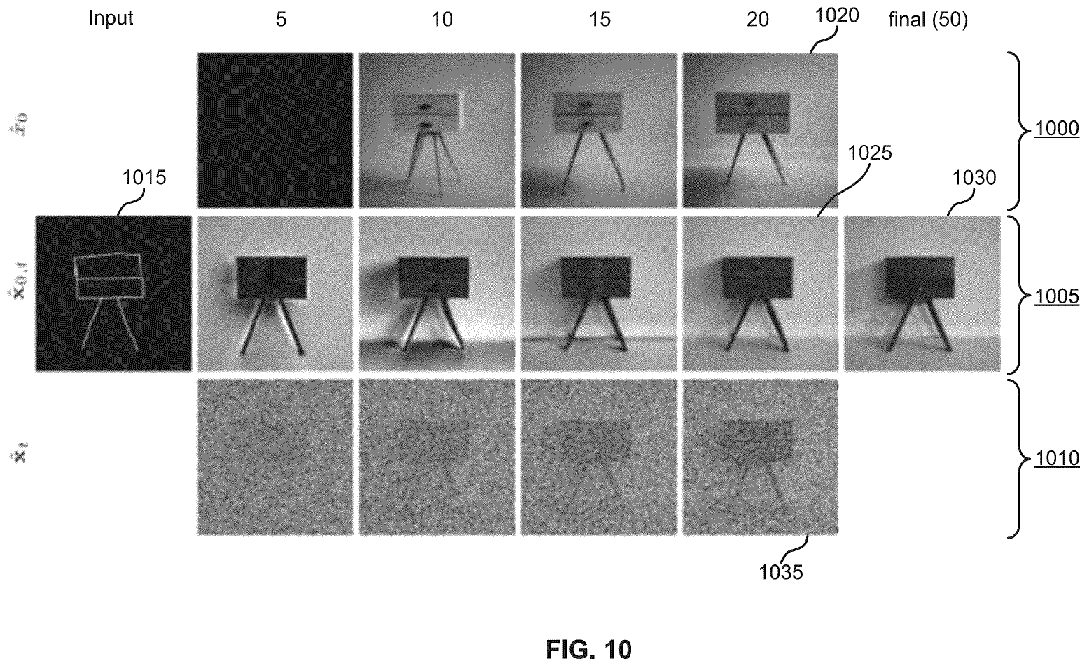

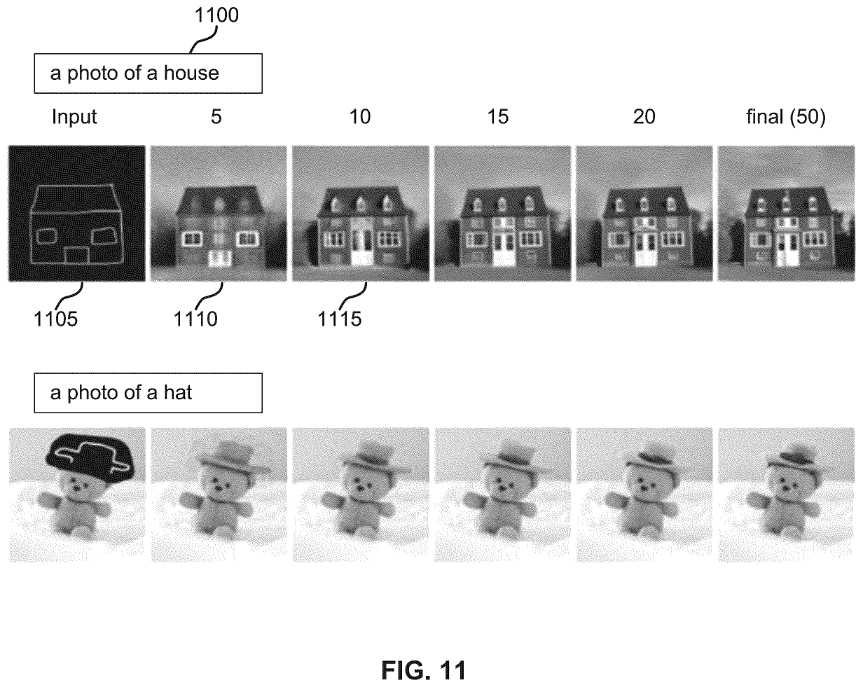

Sketch input 300 is an example of, or includes aspects of, the corresponding element described with reference to FIGS. 10-12. Text prompt 305 is an example of, or includes aspects of, the corresponding element described with reference to FIG. 11.

FIG. 4 shows an example of a method 400 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

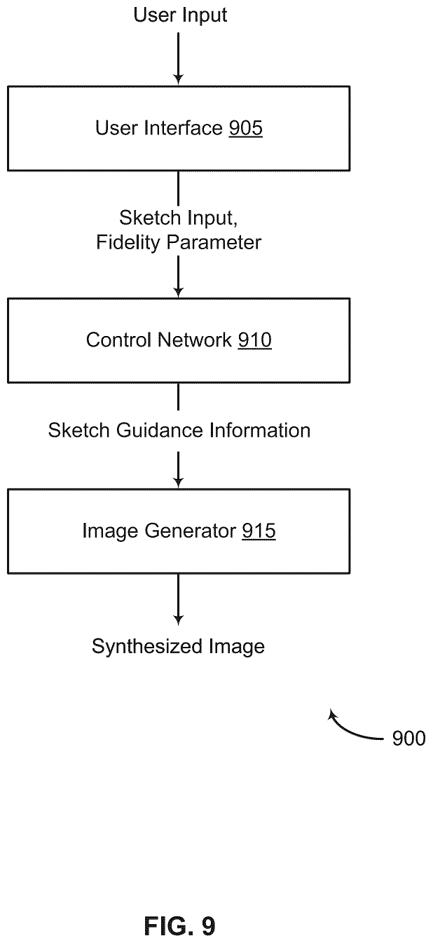

At operation 405, the system obtains a sketch input and a value of a fidelity parameter indicating a level of adherence to the sketch input. In some cases, the operations of this step refer to, or may be performed by, an image generation model as described with reference to FIGS. 5 and 9.

In some examples, a sketch input refers to a doodle or a figure drawn by a user on a digital canvas (e.g., the sketch input is obtained using sketch tool in Photoshop®). The sketch input includes or depicts a scene comprising one or more objects. Additionally, the sketch input includes edge(s) that correspond to each of the one or more objects. The edges indicate the layout structure of a corresponding object. The edges of the object in the sketch input may look inaccurate compared to the object in reality. For example, a plate drawn by a user using sketch tool may have an irregular shape (e.g., not round). In some cases, a sketch input is also referred to as a sketch or a sketch image.

For example, fidelity parameter α is selected from a set of discrete values [0, 0.33, 0.66, 1]. Fidelity parameter α and the corresponding augmented edge map are input to ControlNet adaptor as condition. If a small α is used during inference, the generated image precisely follows the structure of the sketch input. This may lead to artifacts if the sketch input is rough and unrealistic (e.g., from layman users). If a large α is used during inference time, the generated image roughly follows the sketch input and looks realistic. By selecting fidelity parameter α, the image generation model can handle sketch-to-image generation where the sketch input is a rough sketch (layman users) and a precise/artistic sketch (professional users).

At operation 410, the system encodes, using a control network of an image generation model, the sketch input and the value of the fidelity parameter to obtain sketch guidance information. In some cases, the operations of this step refer to, or may be performed by, an image generation model as described with reference to FIGS. 5 and 9.

To enable users to control how well the output image should follow the sketch input, in some embodiments, the image generation model receives a fidelity parameter corresponding to a distortion level α (e.g., the ControlNet adaptor receives the fidelity parameter as class labels. The image generation model includes backbone U-Net and ControlNet adaptor. The backbone U-Net is a text to image model (i.e., an image generator). The image generator remains fixed during training. Parameters of the ControlNet adaptor are initialized from the encoder part of the U-Net.

At operation 415, the system generates, using the image generation model, a synthesized image based on the sketch guidance information, where the synthesized image depicts an object from the sketch input based on the fidelity parameter. In some cases, the operations of this step refer to, or may be performed by, an image generation model as described with reference to FIGS. 5 and 9. In some examples, the image generation model is trained using training data having a distortion level corresponding to the fidelity parameter.

In some embodiments, the image generation model preserves the structure and layout of the sketch input. For example, the image generation model generates image objects following the structure of the input edge, taking into account the edge condition. The image generation model can extend to scribble guided in-painting by modifying the backbone U-Net to an in-painting model. The image generation model can handle artistic sketch-guided image generation when it is trained using an artistic sketch photo dataset as training set.

### Network Architecture

In FIGS. 5-9, an apparatus and method for image generation are described. One or more embodiments of the apparatus and method include at least one processor; at least one memory including instructions executable by the at least one processor; and a machine learning model comprising parameters in the at least one memory configured to obtain a sketch input and a value of a fidelity parameter indicating a level of adherence to the sketch input, wherein the machine learning model comprises a control network trained to encode the sketch input and the value of the fidelity parameter to obtain sketch guidance information, and wherein the machine learning model further comprises an image generator trained to generate a synthesized image based on the sketch guidance information using training data having a distortion level corresponding to the fidelity parameter.

Some examples of the apparatus and method further include a user interface configured to receive the sketch input and the value of the fidelity parameter. In some examples, the image generator comprises a diffusion model. In some examples, the control network is initialized using parameters from the image generator.

Some examples of the apparatus and method further include a data preparation component configured to distort the sketch input based on the distortion level.

FIG. 5 shows an example of an image generation apparatus 500 according to aspects of the present disclosure. The example shown includes image generation apparatus 500, processor unit 505, I/O module 510, user interface 515, memory unit 520, image generation model 525, and training component 545. Image generation apparatus 500 is an example of, or includes aspects of, the corresponding element described with reference to FIG. 1. In an embodiment, image generation model 525 includes control network 530, image generator 535, and data preparation component 540.

Processor unit 505 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 505 is configured to operate a memory array using a memory controller. In other cases, a memory controller is integrated into the processor. In some cases, processor unit 505 is configured to execute computer-readable instructions stored in a memory to perform various functions. In some embodiments, processor unit 505 includes special purpose components for modem processing, baseband processing, digital signal processing, or transmission processing.

Examples of memory unit 520 include random access memory (RAM), read-only memory (ROM), or a hard disk. Examples of memory unit 520 include solid state memory and a hard disk drive. In some examples, memory unit 520 is used to store computer-readable, computer-executable software including instructions that, when executed, cause a processor to perform various functions described herein. In some cases, memory unit 520 contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within memory unit 520 store information in the form of a logical state.

In some examples, at least one memory unit 520 includes instructions executable by the at least one processor unit 505. Memory unit 520 includes image generation model 525 or stores parameters of image generation model 525.

I/O module 510 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 510 includes a user interface (e.g., user interface 515). A user interface may enable a user to interact with a device. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some embodiments of the present disclosure, image generation apparatus 500 includes a computer implemented artificial neural network (ANN) for image generation and image inpainting. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

Accordingly, during the training process, the parameters and weights of the image generation model 525 are adjusted to increase the accuracy of the result (i.e., by attempting to minimize a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some embodiments, image generation apparatus 500 includes a convolutional neural network (CNN) for image generation and image inpainting. CNN is a class of neural networks that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

According to some embodiments, user interface 515 provides a sketch element and user interface 515 receives the sketch input via the sketch element. In some examples, user interface 515 provides a fidelity parameter selection element and user interface 515 receives the value of the fidelity parameter via the fidelity parameter selection element. In some examples, user interface 515 receives an edit to the sketch input. User interface 515 modifies the sketch input based on the edit to obtain a modified sketch input. In some examples, user interface 515 displays a preview of the synthesized image, where the edit is received in response to the preview.

According to some embodiments, user interface 515 is configured to receive the sketch input and the value of the fidelity parameter. User interface 515 is an example of, or includes aspects of, the corresponding element described with reference to FIG. 9.

According to some embodiments, image generation model 525 obtains a sketch input and a value of a fidelity parameter indicating a level of adherence to the sketch input. In some examples, image generation model 525 encodes, using a control network 530 of image generation model 525, the sketch input and the value of the fidelity parameter to obtain sketch guidance information. In some examples, image generation model 525 generates a synthesized image based on the sketch guidance information, where the synthesized image depicts an object from the sketch input based on the fidelity parameter. In some examples, the image generation model 525 is trained using training data having a distortion level corresponding to the fidelity parameter.

In some examples, image generation model 525 generates a modified image based on the modified sketch input. In some examples, image generation model 525 performs inpainting operation on a portion of an input image based on the sketch input. In some examples, image generation model 525 obtains a text prompt, where the synthesized image is generated based on the text prompt. Image generation model 525 is an example of, or includes aspects of, the corresponding element described with reference to FIG. 9.

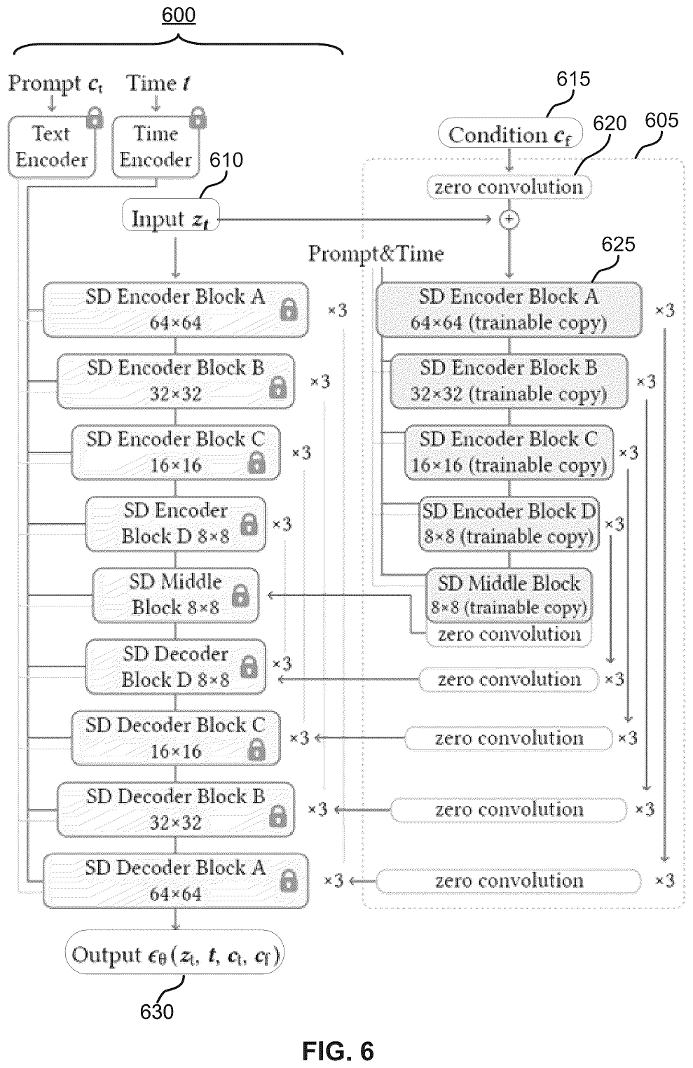

In one embodiment, image generation model 525 includes control network 530, image generator 535, and data preparation component 540. In some examples, the control network 530 is initialized using parameters from the image generator 535. Control network 530 is an example of, or includes aspects of, the corresponding element described with reference to FIGS. 6, 7, and 9.

In some examples, the image generator 535 includes a diffusion model. Image generator 535 is an example of, or includes aspects of, the corresponding element described with reference to FIG. 9.

According to some embodiments, data preparation component 540 generates a preliminary sketch input based on the image. In some examples, data preparation component 540 distorts the preliminary sketch input based on the distortion level to obtain the sketch input. In some examples, data preparation component 540 warps the preliminary sketch input based on the distortion level. In some examples, data preparation component 540 obtains a set of transformation parameters based on the distortion level. In some examples, data preparation component 540 performs affine transformation on the preliminary sketch input based on the set of transformation parameters to obtain the sketch input. In some examples, data preparation component 540 performs edge detection on the image to obtain the sketch input. In some examples, data preparation component 540 performs entity segmentation on the image to obtain the sketch input. In some examples, data preparation component 540 generates a set of sketch inputs based on the image, where each of the set of sketch inputs is based on a set of stroke attributes corresponding to a different sketch style. According to some aspects, data preparation component 540 is configured to distort the sketch input based on the distortion level.

According to some embodiments, training component 545 initializes an image generation model 525. In some examples, training component 545 creates a training set including an image, a sketch input corresponding to the image, and a distortion level of the sketch input. In some examples, training component 545 trains, using the training set, the image generation model 525 to generate images based on the sketch input and a fidelity parameter corresponding to the distortion level. In some examples, training component 545 fixes parameters of an image generator 535 of the image generation model 525. In some examples, training component 545 iteratively updates parameters of a control network 530 of the image generation model 525.

According to some embodiments, training component 545 initializes image generation model 525. Training component 545 is used to train control network 530. In some cases, training component 545 (shown in dashed line) is implemented on an apparatus other than image generation apparatus 500.

FIG. 6 shows an example of an image generation model comprising a control network according to aspects of the present disclosure. The example shown includes U-Net 600, control network 605, noisy image 610, conditioning vector 615, zero convolution layer 620, trainable copy 625, and learned network 630.

ControlNet is a neural network structure to control image generation models by adding extra conditions. In some embodiments, a ControlNet architecture copies the weights from some of the neural network blocks of the image generation model to create a “locked” copy and a “trainable” copy 625. The “trainable” one learns your condition. The “locked” copy preserves the parameters of the original model. The trainable copy 625 can be tuned with a small dataset of image pairs, while preserving the locked copy ensures that original model is preserved.

As an example architecture shown in FIG. 6, the image generation model comprises U-Net 600 (the left-hand side) and control network 605 (the right-hand side). In some embodiments, a ControlNet architecture can be used to control a diffusion U-Net 600 (i.e., to add controllable parameters or inputs that influence the output). Encoder layers of the U-Net 600 can be copied and tuned. Then zero convolution layers can be added. The output of the control network 605 can be input to decoder layers of the U-Net 600.

In an embodiment, Stable Diffusion's U-Net is connected with a ControlNet on the encoder blocks and middle block. The locked blocks (light gray) show the structure of Stable Diffusion (U-Net architecture). The trainable copy blocks (dark gray) and the zero convolution layers are added to build a ControlNet. In some cases, trainable copy 625 may be referred to as a trainable copy block or a trainable block.

In some embodiments, one or more zero convolution layers (e.g., 620) are added to the trainable copy 625. A “zero convolution” layer 620 is 1×1 convolution with both weight and bias initialized as zeros. Before training, the zero convolution layers output all zeros. Accordingly, the ControlNet will not cause any distortion. As the training proceeds, the parameters of the zero convolution layers deviate from zero and the influence of the ControlNet on the output grows.

Given an input image z₀, image diffusion algorithms progressively add noise to the image and produce a noisy image zₜ, where t represents the number of times noise is added. Given a set of conditions including time step t, text prompts cₜ, as well as a task-specific condition c_{f}, image diffusion algorithms learn a network ϵ_{θ} to predict the noise added to the noisy image zₜ with:

$$L = {E}_{{z}_{0 ,} t , {c}_{t} , {c}_{f} , ϵ ∼ N ( 0 , 1 )} [ {‖ ϵ - ϵ ( {z}_{t} , t , {c}_{t} , {c}_{f} ) ‖}_{2}^{2} ] \qquad ( 1 )$$

where L is the overall learning objective of the entire diffusion model. This learning objective is directly used in fine-tuning diffusion models with ControlNet. The output from U-Net 600 includes parameters corresponding to learned network 630, e.g., output ϵ_{θ}(zₜ, t, cₜ, c_{f}).

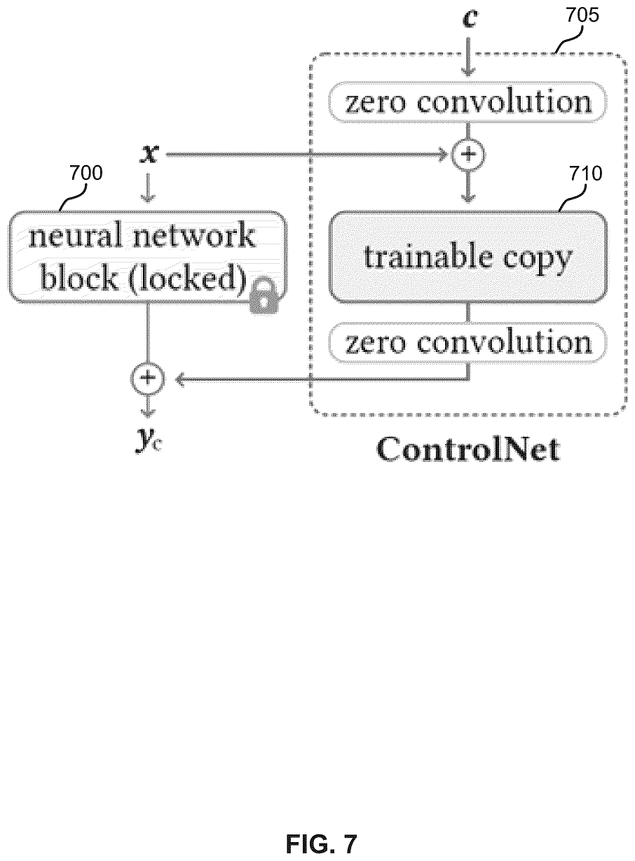

Control network 605 is an example of, or includes aspects of, the corresponding element described with reference to FIGS. 5, 7, and 9. Trainable copy 625 is an example of, or includes aspects of, the corresponding element described with reference to FIG. 7.

FIG. 7 shows an example of a control network 705 of an image generation model according to aspects of the present disclosure. The example shown includes neural network block 700, control network 705, and trainable copy 710.

In some examples, a neural network block 700 takes a feature map x as input and outputs another feature map y. To add a ControlNet (i.e., control network 705) to such a block, some embodiments lock the original block and create a trainable copy 710 and connect them together using zero convolution layers, i.e., 1×1 convolution with both weight and bias initialized to zero. Here c is a conditioning vector that is added to the network.

In an embodiment, Stable Diffusion's U-Net is connected with a ControlNet on the encoder blocks and middle block. The locked neural network block 700 (light gray) shows a portion of the structure of Stable Diffusion (U-Net architecture). The trainable copy 710 (dark gray) and the zero convolution layers are added to build a ControlNet. In some cases, trainable copy 710 may be referred to as a trainable copy block or a trainable block.

Control network 705 is an example of, or includes aspects of, the corresponding element described with reference to FIGS. 5, 6, and 9. Trainable copy 710 is an example of, or includes aspects of, the corresponding element described with reference to FIG. 6.

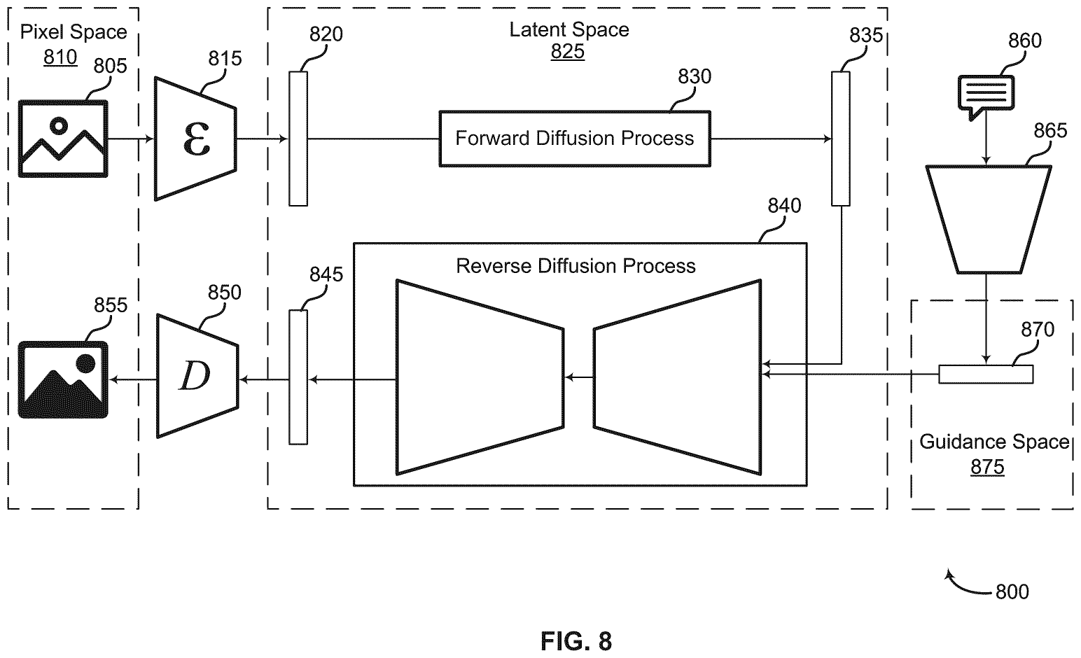

FIG. 8 shows an example of a guided latent diffusion model 800 according to aspects of the present disclosure. The guided latent diffusion model 800 depicted in FIG. 8 is an example of, or includes aspects of, the corresponding element described with reference to FIG. 5.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 800 may take an original image 805 in a pixel space 810 as input and apply and image encoder 815 to convert original image 805 into original image features 820 in a latent space 825. Then, a forward diffusion process 830 gradually adds noise to the original image features 820 to obtain noisy features 835 (also in latent space 825) at various noise levels.

Next, a reverse diffusion process 840 (e.g., a U-Net ANN) gradually removes the noise from the noisy features 835 at the various noise levels to obtain denoised image features 845 in latent space 825. In some examples, the denoised image features 845 are compared to the original image features 820 at each of the various noise levels, and parameters of the reverse diffusion process 840 of the diffusion model are updated based on the comparison. Finally, an image decoder 850 decodes the denoised image features 845 to obtain an output image 855 in pixel space 810. In some cases, an output image 855 is created at each of the various noise levels. The output image 855 can be compared to the original image 805 to train the reverse diffusion process 840.

In some cases, image encoder 815 and image decoder 850 are pre-trained prior to training the reverse diffusion process 840. In some examples, they are trained jointly, or the image encoder 815 and image decoder 850 and fine-tuned jointly with the reverse diffusion process 840.

The reverse diffusion process 840 can also be guided based on a text prompt 860, or another guidance prompt, such as an image, a layout, a segmentation map, etc. The text prompt 860 can be encoded using a text encoder 865 (e.g., a multimodal encoder) to obtain guidance features 870 in guidance space 875. The guidance features 870 can be combined with the noisy features 835 at one or more layers of the reverse diffusion process 840 to ensure that the output image 855 includes content described by the text prompt 860. For example, guidance features 870 can be combined with the noisy features 835 using a cross-attention block within the reverse diffusion process 840.

FIG. 9 shows an example of a machine learning model according to aspects of the present disclosure. The example shown includes image generation model 900, user interface 905, control network 910, and image generator 915.

In an embodiment, user interface 905 receives a sketch input and a value of a fidelity parameter. The fidelity parameter indicates a level of adherence to the sketch input. User interface 905 is an example of, or includes aspects of, the corresponding element described with reference to FIG. 5.

Image generation model 900 obtains the sketch input and the value of the fidelity parameter. Image generation model 900 is an example of, or includes aspects of, the corresponding element described with reference to FIG. 5.

Control network 910 is trained to encode the sketch input and the value of the fidelity parameter to obtain sketch guidance information. Control network 910 is an example of, or includes aspects of, the corresponding element described with reference to FIGS. 5-7. Image generator 915 is trained to generate a synthesized image based on the sketch guidance information using training data having a distortion level corresponding to the fidelity parameter. Image generator 915 is an example of, or includes aspects of, the corresponding element described with reference to FIG. 5.

### Image Generation Using Diffusion

FIG. 10 shows an example of predicted images 1005 at various time steps via a diffusion process according to aspects of the present disclosure. The example shown includes sampling results 1000, predicted images 1005, noise maps 1010, sketch input 1015, sampling image 1020, intermediate predicted image 1025, final predicted image 1030, and intermediate noise map 1035.

In some examples, diffusion models are based on a neural network architecture known as a U-Net. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) : = N ( {x}_{t - 1} ; {μ}_{θ} ( {x}_{t} , t ) , {\sum }_{θ} ( {x}_{t} , t ) ) . \qquad ( 2 )$$

The joint probability of a sequence of samples in the Markov chain can be written as a product of conditionals and the marginal probability:

$$\begin{matrix}{x}_{T} : {p}_{θ} ( {x}_{0 : τ} ) : = p ( {x}_{T} ) {\prod }_{t = 1}^{T} & {p}_{θ} ( {x}_{t - 1} \vert {x}_{t} )\end{matrix} , \qquad ( 3 )$$

where p(x_{T})=N(x_{T}; 0, I) is the pure noise distribution as the reverse process takes the outcome of the forward process, a sample of pure noise, as input and Πₜ₌₁^{T} p_{θ}(xₜ₋₁|xₜ) represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data. The training system then updates parameters of the model based on the comparison. For example, parameters of a U-Net may be updated using gradient descent. Time-dependent parameters of the Gaussian transitions can also be learned.

In some examples, the image generation model (with reference to FIGS. 5 and 9), receives sketch input 1015, text prompt “a photo of a nightstand” and a fixed random seed as inputs. The image generation model runs 50 steps DDIM sampling to obtain the final output. To facilitate interactive editing, we want a fast preview that has consistent structure and color with the final output. With smaller time steps, the DDIM sampling results \hat{x}₀ have inconsistent structure and color with the final output. The intermediate noise maps îₜ are hard to recognize. Although slightly noisy, the predicted final results through the generation process \hat{x}_{0,t} have same recognizable structure and color as the final output.

As shown in FIG. 10, the first row includes sampling results 1000. The second row includes predicted images 1005. The third row includes noise maps 1010. Sketch input 1015 is an image drawn by a user comprising inaccurate edges. Sampling image 1020 is a sampling result at time step 20. The image generation model generates intermediate predicted image 1025 at time step 20. The image generation model generates final predicted image 1030 at time step 50. Intermediate noise map 1035 is a noise map at time step 20.

Standard diffusion sampling takes a long time. To achieve real-time, during user editing, there is no need to generate a realistic image. In an embodiment, the image generation model generates a low-quality preview in real-time (e.g., less than 1 second). The preview has a clear recognizable structure and color. Furthermore, the preview has a consistent structure and color with the final output image. Users can easily estimate the structure of the final output from the preview image, and modify the sketch input accordingly to obtain satisfied output. It is found that the \hat{x}_{0,t} with ⅕ of the total number of function evaluations (NFE) provides competitive performance.

In an embodiment, given sketch input 1015, a text prompt (e.g., “a photo of a nightstand”) and a fixed random seed, the image generation model runs 50 steps DDIM sampling with uniform interval to obtain the final output (e.g., final predicted image 1030). With smaller time steps, the DDIM sampling results \hat{x}₀ have inconsistent structure and color compared to the final output. For example, sampling results on the first row have inconsistent structure and color compared to the final output on the second row. The intermediate noise maps \hat{x}ₜ, on the third row, are difficult to recognize. Although slightly noisy, the predicted final results (e.g., intermediate predicted image 1025, final predicted image 1030) through the generation process \hat{x}_{0,t}, on the second row, have the same recognizable structure and color as the final output. When t=10, referring to the third column from the left, the predicted image \hat{x}_{0,t} already have visible and consistent structure and color as the final output (i.e., final predicted image 1030). The \hat{x}_{0,t} at time step t=10 (⅕ of total NFE) is used as fast preview.

Sampling results 1000 is an example of, or includes aspects of, the corresponding element described with reference to FIG. 12. Predicted images 1005 is an example of, or includes aspects of, the corresponding element described with reference to FIG. 12. Noise maps 1010 is an example of, or includes aspects of, the corresponding element described with reference to FIG. 12. Sketch input 1015 is an example of, or includes aspects of, the corresponding element described with reference to FIGS. 3, 11, and 12. Sampling image 1020 is an example of, or includes aspects of, the corresponding element described with reference to FIG. 12. Intermediate predicted image 1025 is an example of, or includes aspects of, the corresponding element described with reference to FIG. 12. Final predicted image 1030 is an example of, or includes aspects of, the corresponding element described with reference to FIG. 12. Intermediate noise map 1035 is an example of, or includes aspects of, the corresponding element described with reference to FIG. 12.

FIG. 11 shows an example of predicted images at various time steps via diffusion process according to aspects of the present disclosure. The example shown includes text prompt 1100, sketch input 1105, first predicted image 1110, and second predicted image 1115. In an example, when t=10, the \hat{x}_{0,t} already have visible and consistent structure and color as the final output. The \hat{x}_{0,t} at time step t=10 (⅕ of total NFE) is used as fast preview.

Text prompt 1100 is an example of, or includes aspects of, the corresponding element described with reference to FIG. 3. Sketch input 1105 is an example of, or includes aspects of, the corresponding element described with reference to FIGS. 3, 10, and 12.

FIG. 12 shows an example of predicted images 1205 at various time steps via diffusion process according to aspects of the present disclosure. The example shown includes sampling results 1200, predicted images 1205, noise maps 1210, sketch input 1215, sampling image 1220, intermediate predicted image 1225, final predicted image 1230, and intermediate noise map 1235.

In some examples, the image generation model (with reference to FIGS. 5 and 9), receives the sketch input 1215, text prompt “a marble sculpture of a horse” and a fixed random seed as inputs. The image generation model runs 50 steps DDIM sampling to obtain the final output. To facilitate interactive editing, the image generation model is configured to output a fast preview because a fast preview has consistent structure and color with the final output (and accordingly a fast preview is desirable). With smaller time steps, the DDIM sampling results \hat{x}₀ have inconsistent structure and color with the final output. The intermediate noise maps \hat{x}ₜ are hard to recognize. Although slightly noisy, the predicted final results through the generation process \hat{x}_{0,t} have the same recognizable structure and color as the final output.

As shown in FIG. 12, the first row includes sampling results 1200. The second row includes predicted images 1205. The third row includes noise maps 1210. Sketch input 1215 is an image drawn by a user comprising inaccurate edges. Sampling image 1220 is a sampling result at time step 20. The image generation model generates intermediate predicted image 1225 at time step 20. The image generation model generates final predicted image 1230 at time step 50. Intermediate noise map 1235 is a noise map at time step 20.

Sampling results 1200 is an example of, or includes aspects of, the corresponding element described with reference to FIG. 10. Predicted images 1205 is an example of, or includes aspects of, the corresponding element described with reference to FIG. 10. Noise maps 1210 is an example of, or includes aspects of, the corresponding element described with reference to FIG. 10. Sketch input 1215 is an example of, or includes aspects of, the corresponding element described with reference to FIGS. 3, 10, and 11. Sampling image 1220 is an example of, or includes aspects of, the corresponding element described with reference to FIG. 10. Intermediate predicted image 1225 is an example of, or includes aspects of, the corresponding element described with reference to FIG. 10. Final predicted image 1230 is an example of, or includes aspects of, the corresponding element described with reference to FIG. 10. Intermediate noise map 1235 is an example of, or includes aspects of, the corresponding element described with reference to FIG. 10.

### Training and Data Preparation

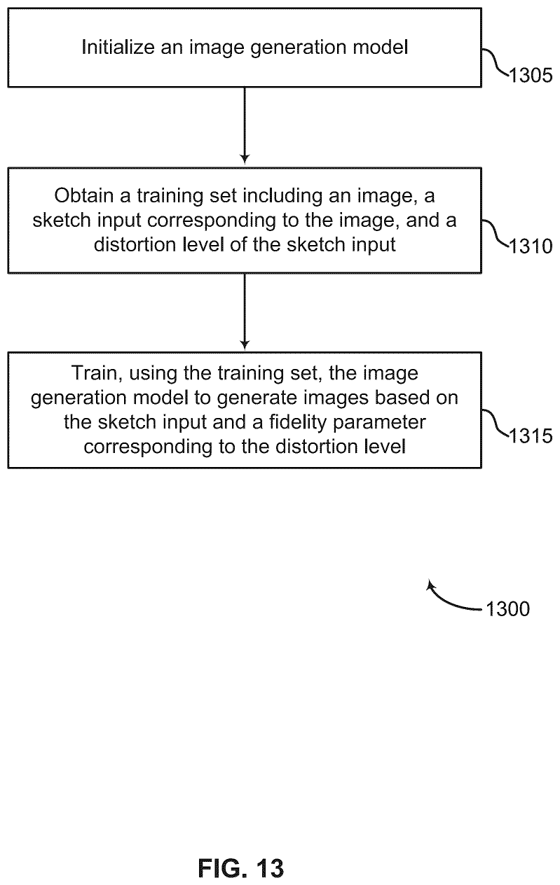

In FIGS. 13-21, a method, apparatus, and non-transitory computer readable medium for image generation are described. One or more embodiments of the method, apparatus, and non-transitory computer readable medium include initializing an image generation model; obtaining a training set including an image, a sketch input corresponding to the image, and a distortion level of the sketch input; and training, using the training set, the image generation model to generate images based on the sketch input and a fidelity parameter corresponding to the distortion level.

Some examples of the method, apparatus, and non-transitory computer readable medium further include generating a preliminary sketch input based on the image. Some examples further include distorting the preliminary sketch input based on the distortion level to obtain the sketch input. Some examples of the method, apparatus, and non-transitory computer readable medium further include warping the preliminary sketch input based on the distortion level.

Some examples of the method, apparatus, and non-transitory computer readable medium further include obtaining a plurality of transformation parameters based on the distortion level. Some examples further include performing affine transformation on the preliminary sketch input based on the plurality of transformation parameters to obtain the sketch input.

Some examples of the method, apparatus, and non-transitory computer readable medium further include performing edge detection on the image to obtain the sketch input.

Some examples of the method, apparatus, and non-transitory computer readable medium further include performing entity segmentation on the image to obtain the sketch input.

Some examples of the method, apparatus, and non-transitory computer readable medium further include fixing parameters of an image generator of the image generation model. Some examples further include iteratively updating parameters of a control network of the image generation model.

Some examples of the method, apparatus, and non-transitory computer readable medium further include generating a plurality of sketch inputs based on the image, wherein each of the plurality of sketch inputs is based on a set of stroke attributes corresponding to a different sketch style.

FIG. 13 shows an example of a method 1300 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system initializes an image generation model. In some cases, the operations of this step refer to, or may be performed by, a training component as described with reference to FIG. 5. In an embodiment, the image generation model comprises an image generator (e.g., backbone U-Net) and a control network (e.g., a ControlNet adaptor). The U-Net is a text to image generative model, which remains fixed during training (e.g., parameters of the image generator are not updated). In some examples, the control network is initialized from the encoder of the U-Net. That is, the training component copies parameters of the image generator of the image generation model to the control network of the image generation model.

At operation 1310, the system creates a training set including an image, a sketch input corresponding to the image, and a distortion level of the sketch input. In some cases, the operations of this step refer to, or may be performed by, a data preparation component and a training component as described with reference to FIG. 5. In various examples, obtaining the training set includes obtaining pre-existing training data or creating a custom training set.

In some embodiments, to simulate the inaccurate edges drawn by layman users, the data preparation component (with reference to FIG. 5) performs random affine transformation and random image warping. The level of these two transformations is controlled by distortion level α.

In some examples, the data preparation component samples the scaling parameter s uniformly from [−s_{range}, s_{range}], where s_{range}=sₘₐₓ*α, sₘₐₓ=5% and α∈[0, 1]. When α=0, then s_{range}=s=0, which means the scale is left unchanged. As α increases, the scaling parameter s has high probability to be a large value (in absolute value). If s has a large absolute value, the edge map may strongly scale up or down. This way, the image generation model controls the maximum sampled scale change by α. Similarly, the data preparation component samples the shifting parameters x and y, and rotation parameter r. The shifting parameters are controlled by α, where xₘₐₓ=yₘₐₓ=rₘₐₓ=3%. After sampling the four parameters (e.g., x, y, r and s), the data preparation component constructs the affine transformation matrix and applies to the edge map.

Layman users may not be able to draw straight lines or perfect circle. To simulate this effect, the data preparation component applies image warping to the edge map (e.g., using WarpGAN method). For example, the data preparation component uniformly samples 8 anchor points from each side of the image, and obtains 64 anchor points in total. Similar to the scaling parameter s, the data preparation component samples the warp offset w where wₘₐₓ=20%. Large w would lead to strong image warping effect in the edge map.

At operation 1315, the system trains, using the training set, the image generation model to generate images based on the sketch input and a fidelity parameter corresponding to the distortion level. In some cases, the operations of this step refer to, or may be performed by, a training component as described with reference to FIG. 5. In an embodiment, the affine transformation parameters (such as x, y, r and s) and warp offset w are controlled by the same distortion level α. Accordingly, the image generation model generates images based on the sketch input and a fidelity parameter corresponding to the distortion level (e.g., by adjusting the value of α).

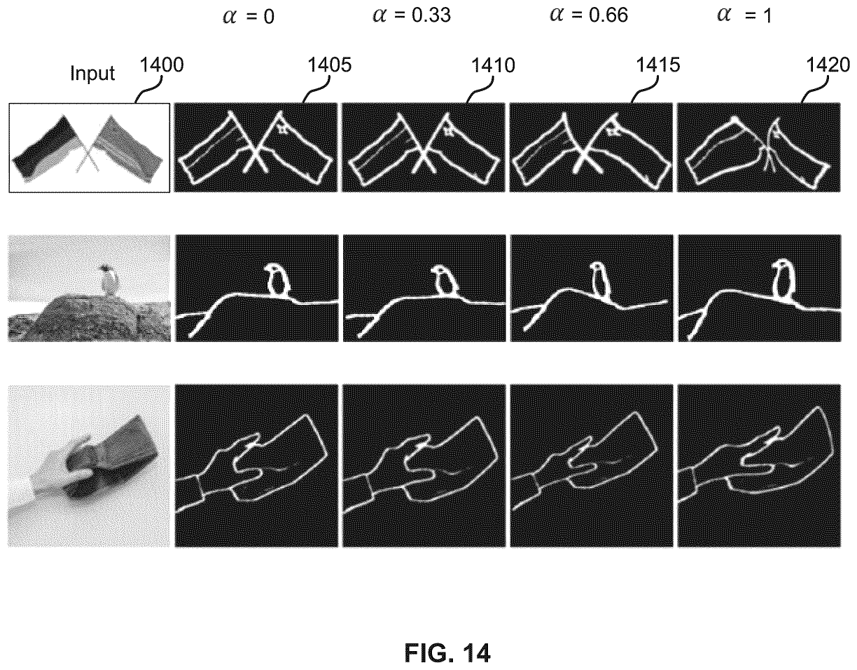

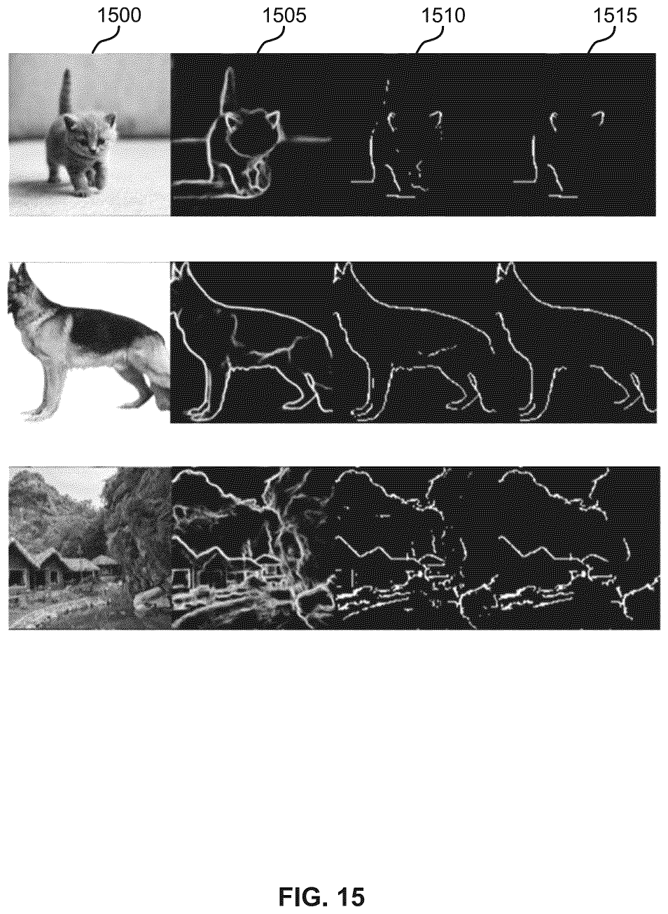

FIG. 14 shows an example of affine transformation and image warping according to aspects of the present disclosure. The example shown includes image 1400, first sketch input 1405, second sketch input 1410, third sketch input 1415, and fourth sketch input 1420. Image 1400 is an example of, or includes aspects of, the corresponding element described with reference to FIGS. 15-17.

To simulate the inaccurate edges users provided, some embodiments perform affine transformation and image warping to an edge map. The level of distortion is controlled by distortion level α. When α=0, the edges are not distorted. As α increases, the data preparation component (with reference to FIG. 5) is configured to perform stronger and stronger distortion to the edges. As an example shown in FIG. 14, image 1400 is a training image used to create one or more sketch inputs. First sketch input 1405 corresponds to a first distortion level (i.e., α=0). Second sketch input 1410 corresponds to a second distortion level (i.e., α=0.33). Third sketch input 1415 corresponds to a third distortion level (i.e., α=0.66). Fourth sketch input 1420 corresponds to a fourth distortion level (i.e., α=1). Embodiments of the present disclosure are not limited to the four distortion levels mentioned above.

FIG. 15 shows an example of edge detection according to aspects of the present disclosure. The example shown includes image 1500, first edge map 1505, second edge map 1510, and third edge map 1515. Some embodiments create a set of training pairs (photo and sketch) using conditional augmentation and fast sampling. The set of training pairs is also referred to as sketch-photo pairs or photo-sketch pairs.

In some embodiments, to train a control network (e.g., the control network 530 described in FIG. 5), the data preparation component (e.g., data preparation component 540 described in FIG. 5) obtains pairs of sketch images and corresponding photo realistic images. The data preparation component generates rough doodle to simulate the input from layman users, and different style of artistic sketch to simulate the input from professional artists. The different style of artistic sketch may also be referred to as “artistic sketch photo dataset” for professional sketch.

As for rough doodle, given an image 1500, the data preparation component performs steps of edge detection (e.g., holistically-nested edge detection or HED), random thresholding, and removing isolated pixels. The data preparation component, via the above steps, generates “clean HED edge”. In some examples, first edge map 1505 corresponds to output after performing HED edge detection. Second edge map 1510 corresponds to output after random thresholding. Third edge map 1515 corresponds to output after removing isolated pixels.

In some examples, holistically-nested edge detection is an edge detection method. HED performs image-to-image prediction by means of a deep learning model that leverages fully convolutional neural networks and deeply-supervised nets. HED automatically learns rich hierarchical representations (guided by deep supervision on side responses) that are important to resolve the challenging ambiguity in edge and object boundary detection. The term “holistic” in HED, despite not explicitly modeling structured output, aims to train and predict edges in an image-to-image fashion. With “nested”, the said method emphasizes the inherited and progressively refined edge maps produced as side outputs. HED shows that the path along which each prediction is made is common to each of these edge maps, with successive edge maps being more concise.

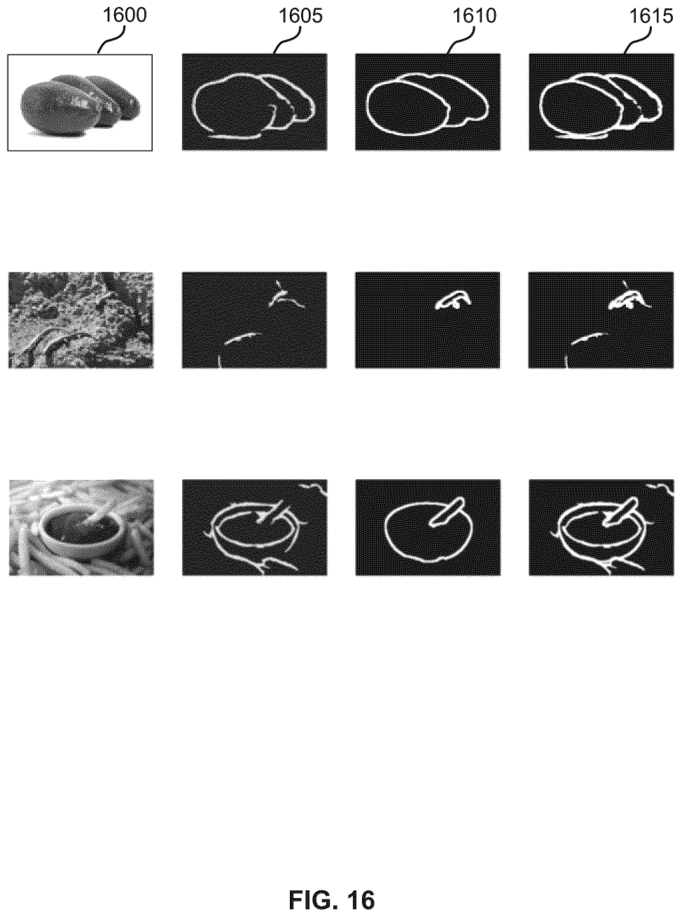

Image 1500 is an example of, or includes aspects of, the corresponding element described with reference to FIGS. 14, 16, and 17. First edge map 1505 is an example of, or includes aspects of, the corresponding element described with reference to FIG. 16. Second edge map 1510 is an example of, or includes aspects of, the corresponding element described with reference to FIG. 16. Third edge map 1515 is an example of, or includes aspects of, the corresponding element described with reference to FIG. 16.

FIG. 16 shows an example of edge detection according to aspects of the present disclosure. The example shown includes image 1600, first edge map 1605, second edge map 1610, and third edge map 1615. In some embodiments, the data preparation component obtains entity segmentation of image 1600, applies the Sobel filter to the entity segmentation and obtains object boundary edges. The data preparation component sets pixels that do not equal to 0 as 255, removes isolated pixels, dilates the edge, and outputs final “clean entity edge”.

In an embodiment, the data preparation component merges the “clean HED edge” with the “clean entity edge” to obtain the “mixed edge”. That is, the mixed edge is generated based on a combination of clean HED edge and clean entity edge. For training the image generation model for scribble-to-image tasks, the data preparation component randomly samples three types of edges. For training the image generation model for scribble inpainting tasks, the data preparation component calculates the intersection between the mask and edges. The data preparation component chooses the “mixed edge” if the pixel intersection between the “clean HED edge” and mask, and the pixel intersection between the “clean entity edge” and mask are smaller than a pre-determined threshold (e.g., 5%). In some cases, the data preparation component randomly dilates or erodes one or more edges.

Referring to FIG. 16, for example, first edge map 1605 corresponds to output after performing HED edge detection. Second edge map 1610 corresponds to clean entity edge. Third edge map 1615 corresponds to mixed edge, i.e., a combination of first edge map 1605 and second edge map 1610 (i.e., clean HED edge and clean entity edge, respectively).

Image 1600 is an example of, or includes aspects of, the corresponding element described with reference to FIGS. 14, 15, and 17. First edge map 1605 is an example of, or includes aspects of, the corresponding element described with reference to FIG. 15. Second edge map 1610 is an example of, or includes aspects of, the corresponding element described with reference to FIG. 15. Third edge map 1615 is an example of, or includes aspects of, the corresponding element described with reference to FIG. 15.

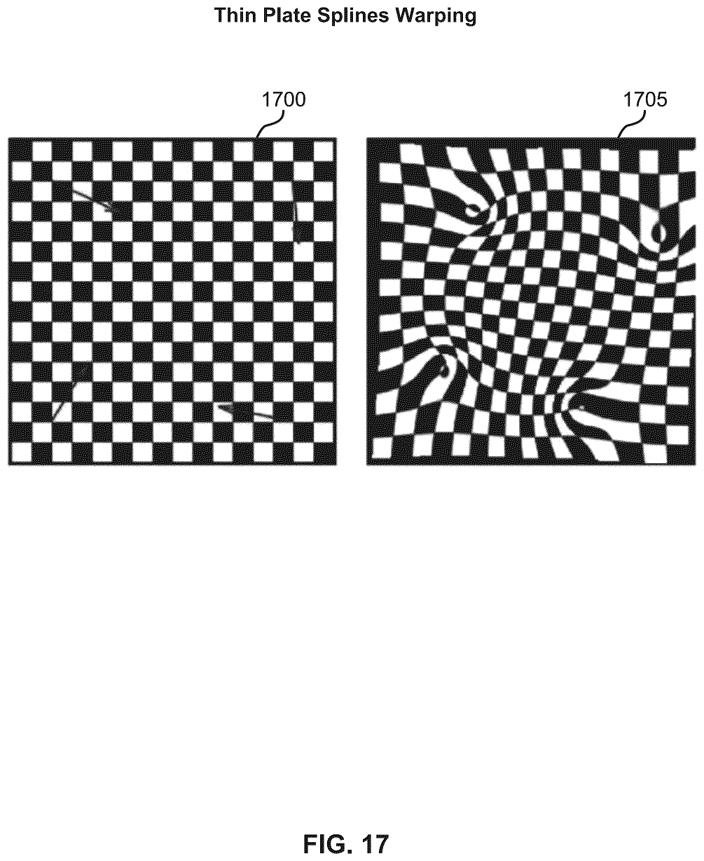

FIG. 17 shows an example of image warping effect according to aspects of the present disclosure. The example shown includes image 1700 and modified image 1705. Image 1700 is an example of, or includes aspects of, the corresponding element described with reference to FIGS. 14-16. In some examples, layman users may not draw straight lines or perfect circle. To simulate this effect, some embodiments apply image warping to the edge map following WarpGAN. In some cases, the data preparation component (with reference to FIG. 5) uniformly samples 8 anchor points from each side of image 1700, and obtains 64 anchor points in total. Similar to s, the data preparation component samples the warp offset w where wₘₐₓ=20%. Large w would lead to strong image warping effect in the edge map.

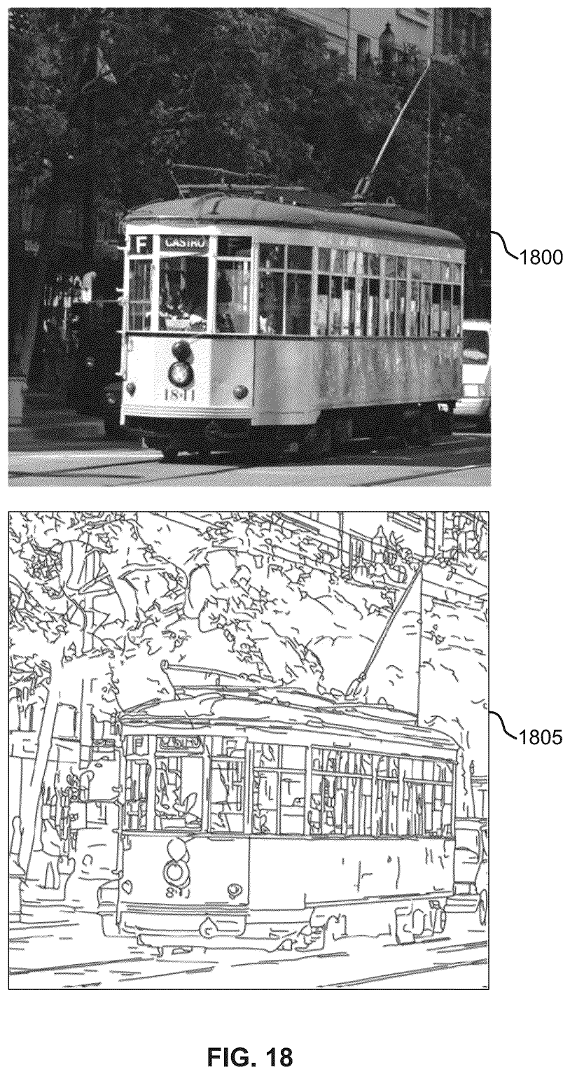

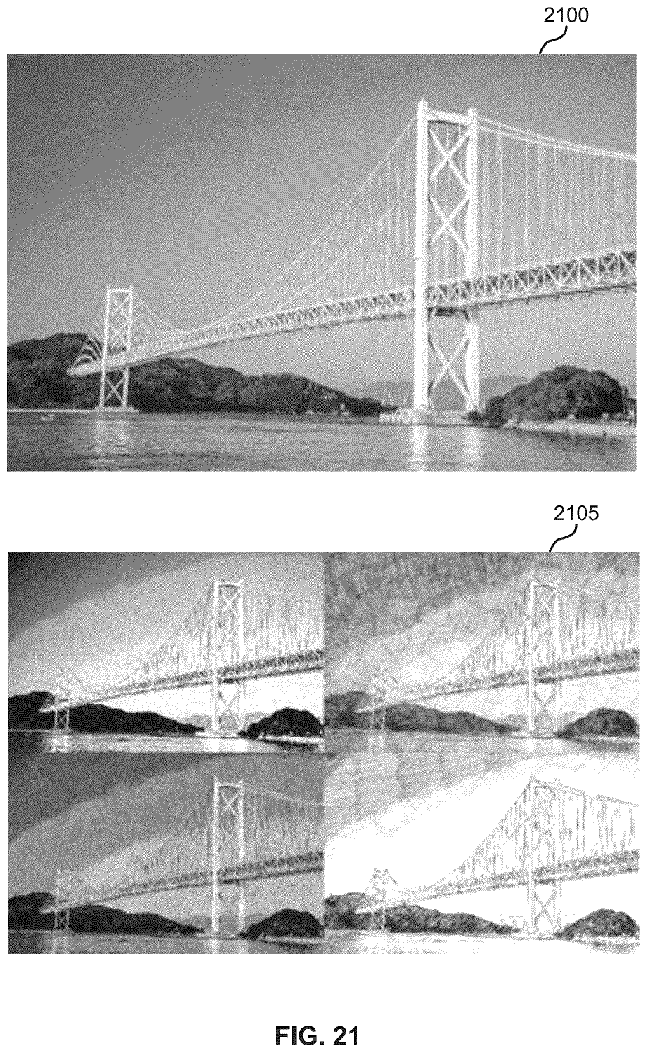

FIG. 18 shows an example of artistic sketch photo creation according to aspects of the present disclosure. The example shown includes original photo 1800 and extracted outlines 1805. Original photo 1800 is an example of, or includes aspects of, the corresponding element described with reference to FIG. 21.

There are different types or styles of drawings that professional creators make. To cover many types of drawings, some embodiments manipulated each “stroke” and “shading” separately. First, the data preparation component (with reference to FIG. 5) is configured to extract outlines from photos using line drawing generation methods to separate “strokes” from “shading/color”. The data preparation component generates an image comprising extracted outlines 1805 based on original photo 1800. Extracted outlines 1805 include information related to strokes, but does not contain information about shading.

Then, the data preparation component defines a set of characteristics that make the drawing style. The data preparation component is configured to mimic each “characteristic” and makes them parameterized so each one may be customized or randomized separately (e.g. making a stroke slightly curved to simulate a line drawn by hand, which is also referred to as hand curve parameter).

Strokes have multiple characteristics. we gave different combination of characteristics to strokes, shading/color. That makes “type” or “style” of the drawing and mimics realistic drawings. Then, we combined the strokes and shading/color to finish the “drawing” or “rough painting”. Here are the main characteristics for strokes (i.e., parameters). The parameters related to strokes include, but are not limited to, amount, medium, pen width, delete length, minimum length for sub strokes, hand curve and its ratio, sub strokes ratio, roughness, opacity, offset of sub-strokes and its ratio, width, opacity for sub-strokes.

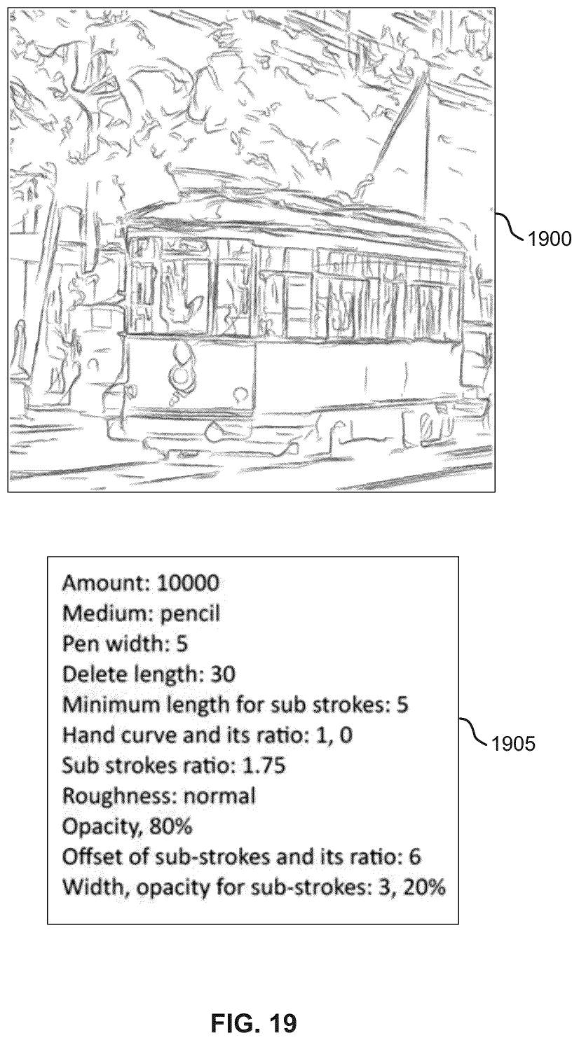

FIG. 19 shows an example of artistic sketch photo 1900 creation according to aspects of the present disclosure. The example shown includes sketch photo 1900 and parameters 1905. For example, the sketch photo 1900 has its parameter(s). The combination of each parameter defines the style of the strokes (or outline drawing). The data preparation component (with reference to FIG. 5) makes 20 combinations (e.g., templates) that make popular styles of drawing. Here, parameters 1905 include main parameters such as amount, medium, pen width, delete length, etc. When rendering, most parameters are slightly randomized, so drawings have different characteristics.

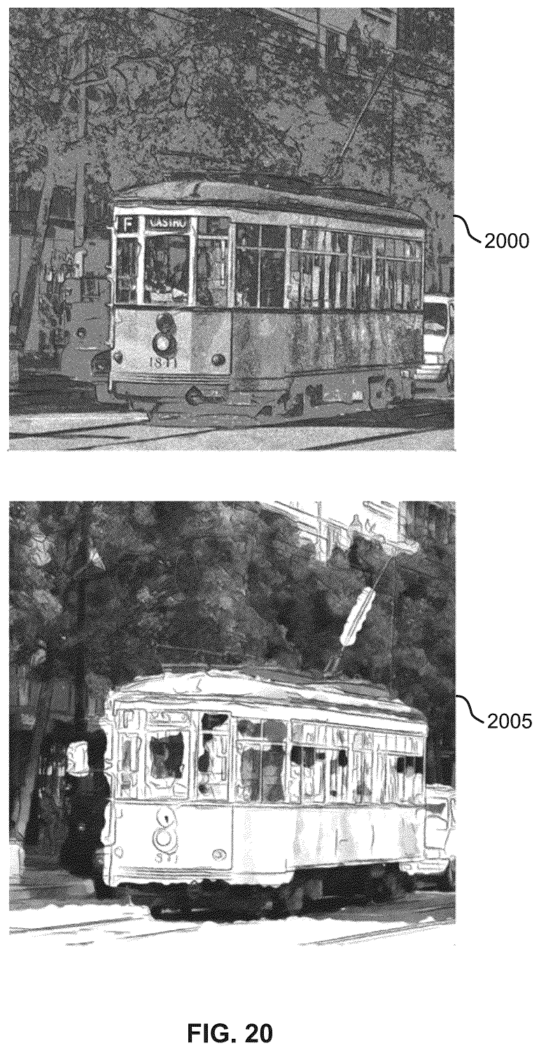

FIG. 20 shows an example of artistic sketch photo creation with shading and color according to aspects of the present disclosure. The example shown includes first image 2000 and second image 2005. The main characteristics for shading/color include, but not limited to, (1) Shading medium; (2) Thickness, darkness; (3) Whole area or only important area to shade; (4) Shading style (cross hatching, single hatching, fill, paint, patterns, . . . ); (5) Monotone—color. There are 47 combinations (also referred to as templates) of characteristics, and the parameters are highly randomized.

In some embodiments, steps of mimicking outline drawings comprise generating outlines from a photo; vectorizing outlines; simulating hand drawing strokes; and applying medium/thickness. Steps of mimicking shading/painting comprise posterizing the color; finding subject to define the area of shading; and applying the shading patterns.

FIG. 21 shows an example of artistic sketch photo database according to aspects of the present disclosure. The example shown includes original photo 2100 and sketch photos 2105. The sketch photo database, for example, includes original photo 2100 and sketch photos 2105 that are generated based on original photo 2100. Sketch photos 2105 show multiple different styles of shading/color. Sketch photos 2105 are different in terms of shading medium, thickness and darkness, shading areas (e.g., the entire area or one or more important areas to shade), shading style (e.g., cross hatching, single hatching, fill, paint, patterns), and monotone (e.g., color). For example, sketch photos 2105 includes four images that are different in terms of color, thickness and darkness (e.g., with regard to strokes), shading medium, shading areas, shading style, etc. Original photo 2100 is an example of, or includes aspects of, the corresponding element described with reference to FIG. 18.

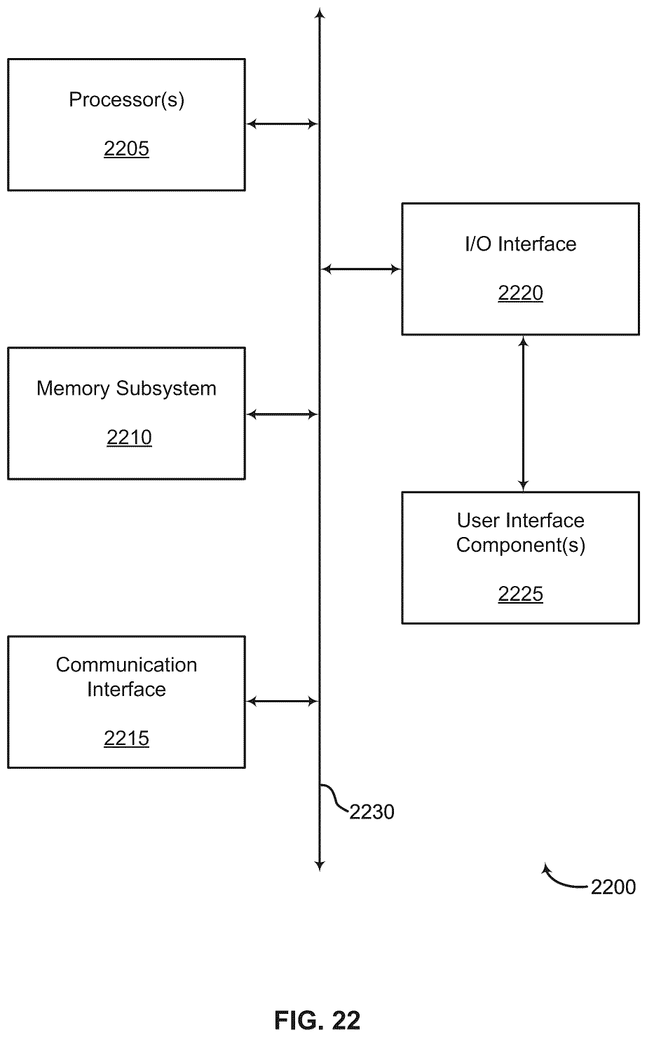

FIG. 22 shows an example of a computing device 2200 for image generation according to aspects of the present disclosure. The example shown includes computing device 2200, processor(s) 2205, memory subsystem 2210, communication interface 2215, I/O interface 2220, user interface component(s) 2225, and channel 2230. In one embodiment, computing device 2200 includes processor(s) 2205, memory subsystem 2210, communication interface 2215, I/O interface 2220, user interface component(s) 2225, and channel 2230.

In some embodiments, computing device 2200 is an example of, or includes aspects of, image generation apparatus 110 of FIG. 1. In some embodiments, computing device 2200 includes one or more processors 2205 that can execute instructions stored in memory subsystem 2210 to obtain a sketch input and a value of a fidelity parameter indicating a level of adherence to the sketch input; encode, using a control network of an image generation model, the sketch input and the value of the fidelity parameter to obtain sketch guidance information; and generate, using the image generation model, a synthesized image based on the sketch guidance information, wherein the synthesized image depicts an object from the sketch input based on the fidelity parameter.

According to some embodiments, computing device 2200 includes one or more processors 2205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some embodiments, memory subsystem 2210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some embodiments, communication interface 2215 operates at a boundary between communicating entities (such as computing device 2200, one or more user devices, a cloud, and one or more databases) and channel 2230 and can record and process communications. In some cases, communication interface 2215 is provided to enable a processing system coupled to a transceiver (e.g., a transmitter and/or a receiver). In some examples, the transceiver is configured to transmit (or send) and receive signals for a communications device via an antenna.

According to some embodiments, I/O interface 2220 is controlled by an I/O controller to manage input and output signals for computing device 2200. In some cases, I/O interface 2220 manages peripherals not integrated into computing device 2200. In some cases, I/O interface 2220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2220 or via hardware components controlled by the I/O controller.

According to some embodiments, user interface component(s) 2225 enable a user to interact with computing device 2200. In some cases, user interface component(s) 2225 include an audio device, such as an external speaker system, an external display device such as a display screen, an input device (e.g., a remote control device interfaced with a user interface directly or through the I/O controller), or a combination thereof. In some cases, user interface component(s) 2225 include a GUI.

Performance of apparatus, systems and methods of the present disclosure have been evaluated, and results indicate embodiments of the present disclosure have obtained increased performance over existing technology. Example experiments demonstrate that the image generation apparatus described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a sketch input and a value of a fidelity parameter indicating a level of adherence to the sketch input;
encoding, using a control network of an image generation model, the sketch input and the value of the fidelity parameter to obtain sketch guidance information; and
generating, using the image generation model, a synthesized image based on the sketch guidance information, wherein the synthesized image depicts an object from the sketch input based on the fidelity parameter.

2. The method of claim 1, wherein obtaining the sketch input comprises:
providing a sketch element in a user interface; and
receiving the sketch input via the sketch element.

3. The method of claim 1, wherein obtaining the value of the fidelity parameter comprises:
providing a fidelity parameter selection element in a user interface; and
receiving the value of the fidelity parameter via the fidelity parameter selection element.

4. The method of claim 1, further comprising:
receiving an edit to the sketch input;
modifying the sketch input based on the edit to obtain a modified sketch input; and
generating, using the image generation model, a modified image based on the modified sketch input.

5. The method of claim 4, further comprising:
displaying a preview of the synthesized image, wherein the edit is received in response to the preview.

6. The method of claim 1, further comprising:
obtaining a text prompt, wherein the synthesized image is generated based on the text prompt.

7. The method of claim 1, wherein:
the image generation model is trained using training data having a distortion level corresponding to the fidelity parameter.

8. A method comprising:
initializing an image generation model;
obtaining a training set including an image, a sketch input corresponding to the image, and a distortion level of the sketch input; and
training, using the training set, the image generation model to generate images based on the sketch input and a fidelity parameter corresponding to the distortion level.

9. The method of claim 8, wherein obtaining the training set comprises:
generating a preliminary sketch input based on the image; and
distorting the preliminary sketch input based on the distortion level to obtain the sketch input.

10. The method of claim 9, wherein distorting the preliminary sketch input comprises:
warping the preliminary sketch input based on the distortion level.

11. The method of claim 9, wherein distorting the preliminary sketch input comprises:
obtaining a plurality of transformation parameters based on the distortion level; and
performing affine transformation on the preliminary sketch input based on the plurality of transformation parameters to obtain the sketch input.

12. The method of claim 8, wherein obtaining the training set comprises:
performing edge detection on the image to obtain the sketch input.

13. The method of claim 8, wherein obtaining the training set comprises:
performing entity segmentation on the image to obtain the sketch input.

14. The method of claim 8, wherein training the image generation model comprises:
fixing parameters of an image generator of the image generation model; and
iteratively updating parameters of a control network of the image generation model.

15. The method of claim 8, wherein obtaining the training set comprises:
generating a plurality of sketch inputs based on the image, wherein each of the plurality of sketch inputs is based on a set of stroke attributes corresponding to a different sketch style.

16. An apparatus comprising:
at least one processor; and
at least one memory including instructions executable by the at least one processor:
a machine learning model comprising parameters in the at least one memory configured to obtain a sketch input and a value of a fidelity parameter indicating a level of adherence to the sketch input, wherein the machine learning model comprises a control network trained to encode the sketch input and the value of the fidelity parameter to obtain sketch guidance information, and wherein the machine learning model further comprises an image generator trained to generate a synthesized image based on the sketch guidance information using training data having a distortion level corresponding to the fidelity parameter.

17. The apparatus of claim 16, further comprising:
a user interface configured to receive the sketch input and the value of the fidelity parameter.

18. The apparatus of claim 16, wherein:
the image generator comprises a diffusion model.

19. The apparatus of claim 16, wherein:
the control network is initialized using parameters from the image generator.

20. The apparatus of claim 16, further comprising:
a data preparation component configured to distort the sketch input based on the distortion level.
